(19) United States
(12) Patent Application Publication
(10) Pub. No.: US 2005/0223743 A1
(43) Pub. Date: Oct. 13, 2005

(54) Process for mass-producing optical elements

(76) Inventor: Kazutaka Hayashi, Tokyo (JP)

Correspondence Address: NIXON & VANDERHYE, PC, 901 NORTH GLEBE ROAD, 11TH FLOOR, ARLINGTON, VA, 22203, US

(21) Appl. No.: 11/103,658

(22) Filed: Apr. 12, 2005

(30) Foreign Application Priority Data
Apr. 12, 2004 (JP) 2004-116362

(51) Int. Cl. C03B 40/02

(52) U.S. Cl. 65/26; 65/374.13

(57) ABSTRACT

A process for highly productively mass-producing optical elements formed of a high-refractivity glass includes repeating the step of precision press-molding a glass preform formed of an optical glass having an Abbe's number (νd) of 30 to less than 40 and a refractive index (nd) of over 1.84 or an optical glass having an Abbe's number (νd) of 40 to 50 and a refractive index (nd) that satisfies the expression (1),
nd>2.16−0.008×νd (1) with a mold made from a material having heat durability against temperatures of higher than 650° C. to produce an optical element formed of said glass.

### FIELD OF THE INVENTION

The present invention relates to a process for producing optical elements by softening glass preforms under heat and precision press-molding them.

### TECHNICAL BACKGROUND

A method in which a preform (preliminary shaped material) formed of an optical glass is softened under heat, introduced into a mold having a high-precision-processing-applied molding surface and press-molded to produce an optical element to which the form of the molding surface of the mold is transferred, is called “precision press-molding”. The above method has been and is employed to produce optical elements such as various lenses including a spherical lens, an aspherical lens, a microlens, etc., a diffraction grating, a lens with a diffraction grating, a lens array, a prism, and the like.

As a typical example of a mold for use in the precision press-molding, conventionally, there is a mold obtained by forming a mold release film containing platinum (Pt), palladium (Pd) or the like on the molding surface of a mold material (base material) that is made from tungsten carbide (WC), titanium carbide (TiC) or titanium nitride (TiN) as a main component and that contains a metal as a sintering auxiliary (binder), as is disclosed in JP-A-7-41326.

Meanwhile, the above mold materials used for producing the above mold are expensive, and they are very hard, so that it requires tremendous periods of time and labors to obtain molds by applying mechanical processing procedures such as grinding, polishing, etc., to such materials. The molding surface of the mold is transferred to a glass preform, and the preform surface to which the molding surface has been transferred constitutes the functional surface (surface that refracts, diffracts, transmits or partially transmits light) of an optical element obtained, so that the molding surface of the mold is required to be a smooth surface free of any roughness. Precision processing of such a molding surface is very troublesome.

Further, when the above noble-metal-containing mold release film is caused to have a scratching or peeling as the press-molding operation at high temperatures is continued, it is required to remove the mold release film once and provide a new mold release film, which takes a tremendously long period of time and a lot of trouble.

It is therefore desirable that a mold for use in the precision press-molding should be usable for a long period of time as long as it can be after it is once produced.

However, the above mold obtained by forming a noble-metal-containing mold release film on the molding surface of a WC-, TiC- or TiN-based mold material disclosed in JP-A-7-41326 has relatively low heat resistance. When the glass to be molded is an optical glass that can be softened at a high temperature since its glass transition temperature and sag temperature are high, the problem of the above mold is that when the precision press-molding of such a glass at a high temperature of 650° C. or higher is repeated, the mold, particularly the mold release film on the molding surface thereof, is damaged to undergo scratching, peeling or fogging, so that optical elements having predetermined surface accuracy can be no longer obtained by press molding.

For increasing the lifetime of the mold, it is desired that the glass for use in the precision press-molding should have the low-temperature softening property that permits press-molding at a low temperature.

On the other hand, in recent years, there are demanded optical glass materials having high refractive indexes for increasing the degree of freedom in optical designing.

For producing optical elements formed of the above high-refractivity glass by the precision press-molding, it has been said that a glass material having both the low-temperature softening property and a high refractive index is required.

### DISCLOSURE OF THE INVENTION

However, conventional glasses having the low-temperature softening property and a high refractive index contain a relatively large amount of alkali metal oxides for imparting the glasses with the low-temperature softening property, and contain a minimum amount of glass-network-structure-forming components such as B₂O₃ for forming a glass. These alkali metal oxides and glass-network-structure-forming components generally contribute relatively little toward imparting the glasses with high refractivity. For producing a precision press-molding glass having a higher refractive index, therefore, it is required to increase the content of a high-refractivity component. However, it has been difficult to increase the content of a high-refractivity-imparting component in a glass composition having a large content of a component that impart the glass with the low-temperature softening property.

When the content of the component for imparting the low-temperature softening property is decreased and when the content of the component for imparting the high refractivity is increased, the glass is not easily softened, and it is required to carry out the precision press-molding of such a glass at a high temperature, so that the problem of the above mold damaging is caused to take place.

Under the circumstances, it has been difficult to mass-produce optical elements stably from a glass having a remarkably high refractive index by the precision press-molding.

The present invention has been made for overcoming the above problem, and it is an object of the present invention to provide a method for highly productively mass-producing highly accurate optical elements formed of a high-refractivity glass by the precision press-molding.

Means to Solve the Problems

For achieving the above object, the present invention provides
(1) a process for mass-producing optical elements, which comprises repeating the step of precision press-molding a glass preform formed of an optical glass having an Abbe's number (νd) of 30 to less than 40 and a refractive index (nd) of over 1.84 or an optical glass having an Abbe's number (νd) of 40 to 50 and a refractive index (nd) that satisfies the expression (1),
   nd>2.16−0.008×νd (1)
with a mold made from a material having heat durability against temperatures of higher than 650° C. to produce an optical element formed of said glass,
(2) a process for mass-producing optical elements, which comprises repeating the step of precision press-molding a glass preform formed of an optical glass having an Abbe's number (νd) of 30 to less than 40 and a refractive index (nd) of over 1.84 or an optical glass having an Abbe's number (νd) of 40 to 50 and a refractive index (nd) that satisfies the expression (1),
   nd>2.16−0.008×νd (1)
with a mold which is made from a mold material selected from silicon carbide, silicon nitride, chromium oxide, zirconium oxide, aluminum oxide or tungsten carbide (free of any metal-based binder) and which has a mold release film formed on its molding surface to produce an optical element formed of said optical glass,
(3) the process for mass-producing optical elements as recited in the above (2), wherein the mold release film is a carbon-containing film,
(4) the process for mass-producing optical elements as recited in any one of the above (1) to (3), wherein the preform to be precision press-molded is provided with an adhesion-preventing film on a surface thereof,
(5) the process for mass-producing optical elements as recited in any one of the above (1) to (4), wherein said optical glass contains B₂O₃ and La₂O₃ as essential components,
(6) the process for mass-producing optical elements as recited in the above (5), wherein said optical glass further contains Gd₂O₃, and
(7) the process for mass-producing optical elements as recited in the above (5) or (6), wherein said optical glass further contains ZnO.

### EFFECT OF THE INVENTION

According to the present invention, there can be provided a process for mass-producing optical elements formed of a high-refractivity glass highly accurately and highly productively by precision press-molding.

### BRIEF DESCRIPTION OF DRAWINGS

FIG. 1 is a drawing showing ranges of the refractive index (nd) and the Abbe's number (νd) of the optical glasses for use in the present invention.

FIG. 2 is a schematic drawing of a precision press-molding apparatus used in Examples of the present invention.

### PREFERRED EMBODIMENTS OF THE INVENTION

First, the optical glass as a material for glass preforms for use in the process for mass-producing optical elements in the present invention will be explained below.

In the present invention, the glass for constituting glass preforms to be used for the precision press-molding is an optical glass having an Abbe's number (νd) of 30 to 50, while it can be classified into the following two glasses on the basis of the ranges of their Abbe's number (νd) and refractive index (nd).

The first glass is a glass having an Abbe's number (νd) of 30 to less than 40 and a refractive index (nd) in the range of over 1.84, and the second glass is a glass having an Abbe's number (νd) of 40 to 50 and a refractive index (nd) in the range represented by the following expression (1).
nd>2.16−0.008×νd (1)

The first glass has a refractive index (nd) in a remarkably high range, and it is a glass that is generally difficult to precision press-mold with a general press mold without impairing the stability of the glass.

Concerning a glass having an Abbe's number (νd) of 30 or more and high refractivity, generally, a glass having a smaller Abbe's number (νd) can have relatively high stability when the refractivity is constant, and as the Abbe's number (νd) is increased, it is more difficult to obtain a stable glass. Like the first glass, therefore, the second glass having a large Abbe's number is also difficult to precision press-mold with a general press mold without impairing the stability of the glass.

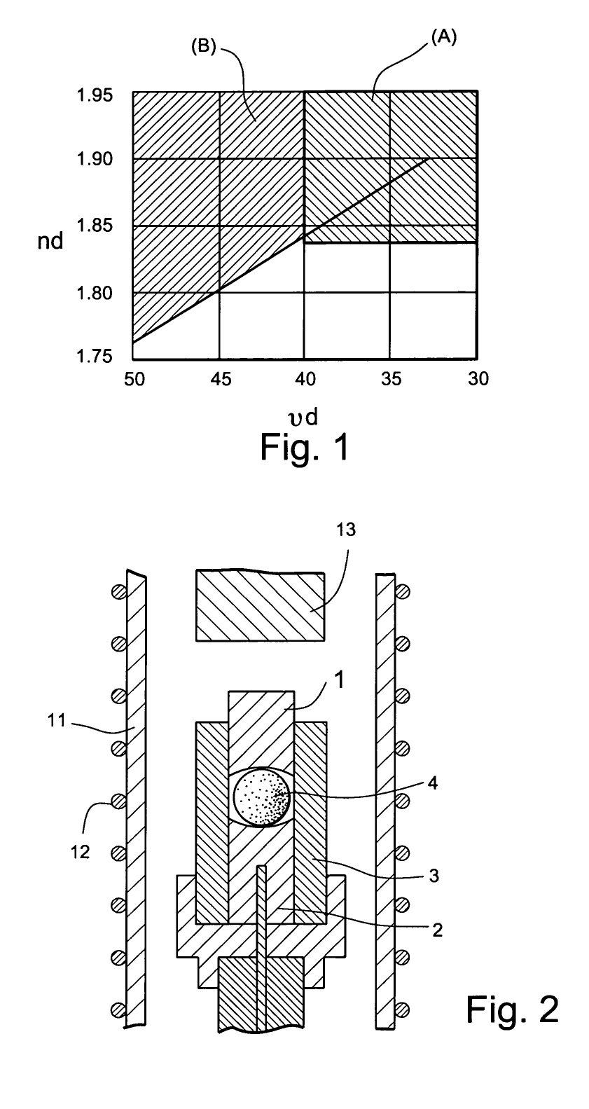

FIG. 1 shows ranges of Abbe's number and refractive index that the first glass and the second glass have. In FIG. 1, a slanting line section indicated by (A) show the range of Abbe's number and refractive index of the first glass, and a slanting line section indicated by (B) show the range of Abbe's number and refractive index of the second glass (excluding a boundary line between the slanting line sections and a white ground section).

As a glass coming under the first glass and the second glass of the present invention, for example, there is a glass having a composition containing B₂O₃ and La₂O₃. These components are preferably introduced in such contents by mol % that the content of B₂O₃ is 20 to 60% and that the content of La₂O₃ is 5 to 22%.

Further, for imparting the B₂O₃-La₂O₃— containing glass with a high refractive index without impairing the stability thereof, it is preferred to introduce Gd₂O₃. Gd₂O₃ is a component that imparts the glass with a high refractive index as well as La₂O₃, and when it is co-present with La₂O₃, it is also a component that improves the glass in stability. The content of Gd₂O₃ by mol % is preferably 1 to 20%.

ZnO is also preferred as a component to be incorporated into the above composition. Although ZnO is a component for imparting the property of the glass being softened at a low temperature like alkali metal oxides, it does not easily decrease the refractive index and glass stability. The content of ZnO by mol % is preferably 5 to 30%.

The composition of the above glass preferably contains, by mol %,
20 to 60% of B₂O₃,
5 to 22% of La₂O₃,
1 to 20% of Gd₂O₃,
5 to 30% of ZnO,
0 to 10% of SiO₂,
0 to 6.5% of ZrO₂,
0 to 10% of Li₂O,
0 to 5% of Na₂O,
0 to 5% of K₂O,
0 to 10% of MgO,
0 to 10% CaO,
0 to 10% SrO,
0 to 10% BaO,
0 to 10% Al₂O₃,
0 to 10% Y₂O₃,
0 to 10% Yb₂O₃,
0 to 8% of TiO₂,
0 to 8% of Ta₂O₅,
0 to 8% of Nb₂O₅,
0 to 8% of WO₃,
0 to 8% of Bi₂O₃, and
0 to 1% of Sb₂O₃.

PbO is a substance that may cause detrimental effects on the environment, it is reduced to precipitate on a glass surface as metal lead during precision press-molding, and the metal lead adheres to a press mold to decrease the accuracy of the molding surface thereof, so that it is preferred to introduce no PbO.

While As₂O₃ may be usable as a refining agent, it is a substance that may cause detrimental effects on the environment and that may also oxidize and damage the molding surface of a press mold during precision press-molding, so that it is preferred to introduce no As₂O₃.

F may be introduced so long as the object of the present invention is not impaired. However, it causes the refractive index of the glass to decrease, and when a preform is shaped, it volatilizes from the glass having a high temperature to cause the glass to have striae, so that it is preferred to introduce no F.

In addition to these, a component like Lu₂O₃ may be introduced. However, it produces less effect for its high price, so that it is not necessary to introduce such a component.

While taking account of the above points, the total content of B₂O₃, La₂O₃, Gd₂O₃, ZnO, SiO₂, ZrO₂, Li₂O, Na₂O, K₂O, MgO, CaO, SrO, BaO, Al₂O₃, Y₂O₃, Yb₂O₃, TiO₂, Ta₂O₅, Nb₂O₅, WO₃, Bi₂O₃ and Sb₂O₃ is preferably 95% or more, more preferably over 98%, still more preferably over 99%, yet more preferably 100%.

The improvement of the glass in stability is required not only for preventing devitrification when a preform is formed from a molten glass but also for preventing the precipitation of a crystal during precision press-molding. With an increase in the temperature for the press-molding, the risk of devitrification taking place during the press-molding increases. When a glass having high stability is used, highly accurate optical elements can be produced while preventing the devitrification even when the temperature for the press-molding is high.

The stability of the glass can be represented by whether the liquidus temperature of the glass is high or low. For preventing the devitrification during the shaping of a preform, particularly, when the preform is shaped during the step of cooling a molten glass gob having a weight equivalent to the weight of one preform after the molten glass gob is separated from a molten glass flowing out (when the preform is shaped directly from a molten glass gob), it is preferred to use a glass having a liquidus temperature of 1,050° C. or lower, and it is more preferred to use a glass having a liquidus temperature of 1,030° C. or lower.

A glass may have a liquidus temperature of up to 1,200° C. so long as the glass in a molten state is cast into a mold and shaped into a shaped material such as a glass plate, a glass block, or the like, followed by application of machining procedures such as cutting, grinding, polishing, etc., to the shaped material in order to produce preforms. However, the viscosity of the glass at the liquidus temperature is preferably 2 dPa·s or more.

The glass for use in the present invention preferably has a sag temperature of 680° C. or lower for making the temperature for press-molding as low as possible.

However, when the sag temperature is decreased to excess while maintaining the above optical constants, the glass is impaired in stability, so that the sag temperature is preferably limited to 590° C. or higher, more preferably limited to over 600° C. As an upper limit of the sag temperature, 760° C. can be employed as a criterion.

The method for producing a preform formed of the above optical glass will be explained below.

The glass preform for use in the precision press-molding in the present invention can be produced by a known method. Examples of the method include a method in which a molten glass is cast into a mold to form a glass block and the glass block is mechanically processed by cutting, grinding, polishing, etc., to shape a preform having a smooth surface and having a weight equal to the weight of a precision press-molded product (to be referred to as “cold processing method” hereinafter), a method in which a molten glass is caused to flow out of a pipe and drop in the form of a glass gob having weight equal to the above end weight (to be referred to as “dropping method” hereinafter), a method in which a molten glass flow is caused to continuously flow out of a pipe, the lower end portion of the molten glass flow is supported with a supporting member directly or while blowing out a gas to apply gas pressure, a narrow portion is formed somewhere in the molten glass flow, a molten glass positioned below the narrow portion is separated to obtain a molten glass gob having the above end weight and the glass gob is shaped (to be referred to as “laminar flow shaping method” hereinafter), and a method in which the support member is caused to move downward in the above method to separate a molten glass positioned below the narrow portion (to be referred to as “descent-separation method” hereinafter).

Any one of the above dropping method, laminar flow shaping method and descent-separation method is called a hot preform shaping method. When the hot preform shaping method and a method in which a molten glass gob is shaped in a state where it is caused to float or nearly float by applying gas pressure to the molten glass gob (to be referred to as “float-shaping method”) are employed, a preform having a smooth surface free of any cutting mark can be produced.

The glass preform is shaped so as to have a proper form depending upon the form of a press-molded product, and examples of the form include the form of a sphere, the form of an ellipsoid of revolution, and the like.

The form of the glass preform, including the form of the above ellipsoid of revolution, preferably has one axis of revolution symmetry. Concerning a form having one such axis of revolution symmetry, there are preforms having a smooth contour line free of any corner or dent in the cross section containing the above axis of revolution symmetry, such as a preform having the form of an ellipse as a contour line in which the minor axis is in agreement with the axis of revolution symmetry in the above cross section. Further, Preferably, when one of angles formed by a line connecting any point on the contour of a preform in the above cross section to the center of the preform gravity on the axis of revolution symmetry and a tangent line contacting the contour on the above point on the contour is taken as θ, and when the above point starts at the axis of revolution symmetry and moves along the contour, the angle θ monotonously increases from 90°, then decreases monotonously and then decreases monotonously to come to be 90° at the other point where the contour crosses the axis of revolution symmetry.

Further, since a glass having a higher temperature exhibits higher reactivity, it is desirable to form an adhesion-preventing film on the surface, preferably the entire surface, of the preform. The adhesion-preventing film includes, for example, a carbon-containing film, a self-organizing film, etc., while a carbon-containing film is preferred. The carbon-containing film preferably has a carbon content, as an atomic ratio, of over 50%, and a hydrogenated carbon film or a carbon film is more preferred. The hydrogenated carbon film can be formed by a CVD method using acetylene, and the carbon film can be formed by a vapor deposition method. These adhesion-preventing films can not only work to prevent adhesion but also work to improve the lubricity between the glass and the molding surface during press-molding.

The adhesion-preventing film formed on the glass preform is preferably a carbon film in both cases where the material of the mold to be described later is silicon carbide and it is zirconium oxide.

For preventing oxidation of the adhesion-preventing film formed on the glass preform, preferably, the preform is handled in a non-oxidizing atmosphere containing nitrogen gas or a mixture of nitrogen and hydrogen when it is in a heated state or a high-temperature state.

The press mold for obtaining an optical element by precision press-molding of the above glass preform will be explained below.

In the present invention, the press mold for use in the precision press-molding is made from a material having heat durability against a temperature of over 650° C., preferably from a material having heat durability against a temperature of over 660° C., still more preferably from a material having heat durability against a temperature of over 680° C. In the present invention, the material having heat durability against a temperature of over 650° C. means a material that permits the mass-production of optical elements by repeated precision press-molding at a pressing temperature of 650° C. (the meaning of “mass-production” will be described later). When the press mold has a mold release film, the heat durability of the material is taken into account by including the heat durability of the mold release film.

The above mold material for the press mold includes a hard ceramic material, and examples thereof include silicon carbide, silicon nitride, chromium oxide, zirconium oxide, aluminum oxide and tungsten carbide (free of any metal-based binder). Of these, silicon carbide and zirconium oxide are preferred, silicon carbide is more preferred, and silicon carbide produced by a CVD method is particularly preferred. Owning to the use of the above hard ceramic material, there can be provided a press mold made of a material having heat durability against a temperature of 650° C. or higher.

In conventionally widely used ultra-hard materials (carbide materials) containing a Co binder (a kind of metal-based binder) such as WC, the metal-based binder begins to undergo an oxidation around 300° C., the strength of the material is decreased around 600° C., and the material generates CO gas and oxygen gas around 700° C., so that the above materials have poor heat durability and hence cannot be used in the process of the present invention. Besides these, ultra-hard materials containing a metal-based binder such as Ni or Cr are not suitable, either.

In the present invention, further, the press-molding is carried out at a temperature higher than a conventional temperature, for example, at a temperature of 650° C. or higher, so that not only the mold material of the mold has high heat durability, but also it is preferred to provide the molding surface of the mold with a mold release film having heat durability against a temperature of over 650° C., preferably a temperature of over 660° C., still more preferably a temperature of over 680° C., for preventing a glass having a very high temperature from reacting with the mold material to be adhere thereto.

The above mold release film is preferably a carbon-containing film, more preferably a film having a carbon content, as an atomic ratio, of over 50%, particularly preferably a hard carbon film.

The hard carbon film has a diamond-like structure and has high hardness, and it exhibits high heat durability in a non-oxidizing atmosphere. For preventing oxidation of the mold release film, preferably, the press mold is handled in a non-oxidizing atmosphere, for example, in a space filled with nitrogen gas or a mixture of nitrogen gas with hydrogen, and it is also preferred to carry out the precision press-molding in the above atmosphere.

As a combination of the mold material of the press mold and the mold release film, preferably, there is a combination of a silicon carbide mold material with a carbon-containing film or a combination of a zirconium oxide mold material with a carbon-containing film.

The precision press-molding in the present invention will be explained below.

In the present invention, the above preform is introduced into the above mold and press-molded (pressed) at a high temperature. The temperature for the press-molding in the present invention is preferably higher than a press-molding temperature employed in a conventional precision press-molding, and it is preferably 650° C. or higher, more preferably 670° C. or higher.

The precision press-molding method for use in the present invention includes the following precision press-molding method 1 and precision press-molding 2.

(Precision Press-Molding Method 1)

This method is a method comprising introducing a glass preform into a press mold, heating the above press mold and the preform together and then precision press-molding the preform.

In the precision press-molding 1, preferably, the press mold and the above glass preform are heated to a temperature at which the glass constituting the preform exhibits a viscosity of 10⁶ to 10¹² dPa·s to carry out the precision press-molding of the preform.

Further, after the press-molding, desirably, the preform is cooled to a temperature at which the above glass exhibits a viscosity of 10¹² dPa·s or more, more preferably 10¹⁴ dPa·s or more, still more preferably 10¹⁶ dPa·s or more, and then a glass molded product is taken out of the press mold.

Under the above conditions, not only the form of molding surface of the press mold can be precisely transferred to the glass, and the precision press-molded product can be taken out without causing any deformation on the precision press-molded product.

(Precision Press-Molding Method 2)

This method is a method comprising preheating the press mold and the glass preform separately, introducing the preheated preform in the press mold and precision press-molding the preform.

According to the precision press-molding method 2, the above glass preform is preheated before its introduction into the press mold, so that the molding cycle time can be decreased, and there can be produced a surface-defect-free optical element having excellent surface accuracy.

In the precision press-molding method 2, preferably, the above preform is preheated to a temperature at which the glass constituting the preform exhibits a viscosity of 10⁹ dPa·s or less, more preferably a viscosity of 10⁹ dPa·s.

Further, preferably, the above preform is preheated while it is caused to float. In this case, the preform is more preferably preheated to a temperature at which the glass constituting the above preform exhibits a viscosity of 10^{5.5} to 10⁹ dPa·s, and is still more preferably preheated a temperature at which the glass exhibits a viscosity of 10^{5.5} or more but less than 10⁹ dPa·s.

Further, the temperature for preheating the press mold is preferably set at a temperature lower than the temperature for preheating the preform. When the temperature for preheating the press mold is set at a temperature lower than the temperature for preheating the preform, the abrasion of the above mold can be decreased. The temperature for preheating the press mold is preferably a temperature at which the glass constituting the above preform exhibits a viscosity of 10⁹ to 10¹² dPa·s.

Then, preferably, the cooling of a glass molded product is started simultaneously with the start of press-molding of the glass preform or during the press-molding the glass preform. After the press-molding, preferably, the press-molded product is cooled to a temperature at which the glass constituting the glass molded product exhibits a viscosity of 10¹² dPa·s or more, and then the glass molded product is taken out of the mold.

The glass molded product obtained by the precision press-molding is taken out of the press mold and is gradually cooled as required. When the optical element as an end product is a lens, an optical thin film may be coated on the glass molded product as required.

The essential constitutional feature in the present invention is that the step of producing an optical element by the above precision press-molding is repeated to mass-produce optical elements.

According to the present invention, preforms formed of an optical glass having a high refractive index and being softenable only at a relatively high temperature can be used as glass preforms, and even if such preforms are used, there is used a press mold made of a mold material having heat durability against a temperature of over 650° C., or a press mold that is made of a hard ceramic material selected from silicon carbide, silicon nitride, chromium oxide, zirconium oxide or aluminum oxide as a mold material and that is provided with a mold release film on its molding surface, so that the mold material and the molding surface of the press mold are not damaged even when the precision press-molding is repeated a number of times, and optical elements excellent in surface accuracy can be hence mass-produced.

The above “mass-producing” of optical elements means that a number of identical optical elements are produced by repeating the step of producing an optical element by the precision press-molding using a single mold, and the number of times of the repeating of the above step refers to the number of times that industrially or commercially pays, for example, at least 100 times, preferably at least 300 times, particularly preferably at least 500 times.

Specific examples of the optical elements mass-produced in the above manner include various lenses such as a spherical lens, an aspherical lens, a microlens, etc., a diffraction grating, a lens with a diffraction grating, a lens array, a prism, and the like.

These optical elements may be provided with an optical thin film such as an anti-reflection film, a total reflection film, a partial reflection film, a film having spectral properties, or the like, as required.

### EXAMPLES

### Example 1

### Example Using Mold of Which the Mold Material is Silicon Carbide

(Production of Glass Preform)

Glass raw materials were weighed so as to obtain each of glasses having compositions shown in Table 1. With regard to each glass, the raw materials were mixed, and the mixture was placed in a platinum crucible and while the mixture was heated at 1,250° C. in an electric furnace in atmosphere for 2 hours, it was melted and stirred to obtain a homogeneous molten glass.

Then, the thus-obtained molten glass was cast into a 40×70×15 mm mold made of carbon and gradually cooled to the glass transition temperature thereof and, immediately thereafter, it was placed in an annealing furnace, annealed around the glass transition temperature for 1 hour and gradually cooled to room temperature in the annealing furnace, to obtain an optical glass. In this manner, optical glasses 1 to 4 shown in Table 1 were obtained. The thus-obtained optical glasses were visually enlarged and observed through a microscope to show that there was found none of a precipitated crystal and a remaining non-melted raw material.

Table 1 shows the refractive index (nd), Abbe's number (νd), glass transition temperature (Tg), sag temperature (Ts) and liquidus temperature (LT) of each of the obtained optical glasses together with their compositions. The optical glasses were measured for the above properties as follows.

(1) Refractive Index (nd) and Abbe's Number (νd)

Optical glasses obtained at a gradually cooling temperature decrease rate of −30° C./hour were measured.

(2) Glass Transition Temperature (Tg) and Sag Temperature (Ts)

Measured with an apparatus for thermomechanical analysis supplied by Rigaku Corporation at a temperature elevation rate of 4° C./minute under a laod of 10 gf.

(3) Liquidus Temperature (LT)

50 grams of a glass sample was placed in a platinum crucible, melted under heat and then maintained at a constant temperature for 2 hours, and the glass sample was observed through a microscope for a presence or an absence of a precipitated crystal. While the above constant temperature was changed at intervals of 10° C., the above operation was carried out at each temperature, and a lowest temperature at which no crystal was found was considered to be a liquidus temperature.

Then, each of the glasses 1 to 4 was refined and homogenized, and molten glass gobs having an intended weight each were separated from the thus-prepared glasses by a dropping method and a descent-separation method. The obtained molten glass gobs were shaped into spherical preforms by a float-shaping method.

Then, with regard to the glass 5, its molten glass was cast into a mold to form a plate-shaped glass and this glass was gradually cooled and then processed into spherical preforms by a cold processing method.

A carbon film was formed on the entire surface of each of these preforms by a CVD method or a vapor deposition method, to produce preforms with a CVD carbon film each and preforms with a vapor deposition carbon film each.

(Production of Optical Element by Precision Press-Molding Method 1)

A preform with a carbon film obtained as described above, formed of the glass 4, was precision press-molded by the precision press-molding method 1 using a pressing apparatus shown in FIG. 2, to give an aspherical lens. Specifically, a glass preform 4 was introduced into between a lower mold member 2 and an upper mold member 1 of a press mold having the upper mold member 1, the lower mold member 2 and a sleeve 3. As the upper mold member 1 and the lower mold member 2 constituting the press mold, there were used mold members each of which was made from silicon carbide by a CVD method and has a molding surface provided with a hard carbon mold release film.

Then, a nitrogen atmosphere was introduced into a quartz tube 11, a heater 12 was electrically powered to heat the inside of the quartz tube 11, and the temperature inside the press mold was set at a temperature at which the glass to be molded exhibited a viscosity of 10⁸ to 10¹⁰ dPa·s. While this temperature was maintained, a pressing rod 13 was caused to move downward to press the upper mold member 1, and the glass preform set in the mold was thereby pressed. The pressing was carried out at a pressure of 8 MPa for a pressing time period of 30 seconds. After the pressing, the pressure for the pressing was removed, and in a state where the glass molded product obtained by the press molding was in contact with the lower mold member 2 and the upper mold member 1, the glass molded product was gradually cooled to a temperature at which the above glass had a viscosity of 10¹² dPa·s or more, and then it was rapidly cooled to room temperature and taken out of the mold, to give an aspherical lens.

After the glass molded product (aspherical lens) was taken out, the step of introducing a preform with the carbon film, formed of the same glass material, into to the above press mold and precision press-molding the preform to produce an aspherical lens was repeated 1,000 times to mass-produce aspherical lenses.

When the above precision press-molding was carried out 1,000 times, no adhesion took place from the initial stage to the last stage, and in any case, no damage was found in the press mold material and the molding surface. Further, all of the thus-obtained aspherical lenses were excellent in surface accuracy and appearance. In the above manner, the aspherical lenses having a high refractive index each were stably mass-produced. The obtained aspherical lenses may be provided with an anti-reflection film each.

In this production example, the glass preform and the mold were heated together, so that the glass and the mold had almost the same temperature, and Table 1 shows this temperature as a press-molding temperature.

(Production of Optical Elements by Precision Press-Molding Method 2)

The same glass preforms provided with a carbon film each as those described above were precision press-molded by the precision press-molding method 2, to give aspherical lenses.

In this method, the preform was preheated up to a temperature at which the glass constituting the preform had a viscosity of 10⁸ dPa·s while the preform was caused to float. On the other hand, the above press mold having the above upper mold member 1, lower mold member 2 and sleeve 3 was heated to a temperature at which the glass constituting the above glass preform exhibited a viscosity of 10⁹ to 10¹² dPa·s, and then the preheated preform was introduced into the cavity of the mold and precision press-molded. The pressure for the pressing was set at 10 MPa. Simultaneously with the start of the pressing, the cooling of the glass and the press mold was started, and they were cooled to a temperature at which the molded glass had a viscosity of 10¹² dPa·s or more. Then, the glass molded product was taken out of the mold to give an aspherical lens.

After the glass molded product (aspherical lens) was taken out, the step of introducing a similarly preheated glass preform with a carbon film, formed of the same glass material, into the above press mold and producing an aspherical lens by precision press-molding was repeated a total of 1,000 times, to mass-produce aspherical lenses.

When the precision press-molding was repeatedly carried out 1,000 times, no adhesion took place from the initial stage to the last stage, and in any case, no damage was found in the press mold material and the molding surface. Further, all of the thus-obtained aspherical lenses were excellent in surface accuracy and appearance. In the above manner, the aspherical lenses having a high refractive index each were stably mass-produced. The obtained aspherical lenses may be provided with an anti-reflection film each.

Table 1 shows press-molding temperatures in this production example. In this case, the temperature for preheating the preforms was higher than the temperature for preheating the mold, so that maximum temperatures to which the mold was exposed were taken as the press-molding temperatures.

TABLE 1

| | Glass 1 | Glass 2 | Glass 3 | Glass 4 | Glass 5 |
|---|---|---|---|---|---|
| B₂O₃ | 51 | 40 | 46 | 43 | 30 |
| La₂O₃ | 11 | 10 | 12 | 14 | 14 |
| Gd₂O₃ | 9 | 7 | 7 | 6 | 7 |
| ZnO | 15 | 20 | 19 | 18 | 21 |
| SiO₂ | 5 | 11 | 4 | 5 | 11 |
| ZrO₂ | 5 | 4 | 5 | 5 | 4 |
| Li₂O | 3 | 5 | 3 | 3 | 4 |
| Na₂O | 0 | 0 | 0 | 0 | 0 |
| K₂O | 0 | 0 | 0 | 0 | 0 |
| MgO | 0 | 0 | 0 | 0 | 0 |
| CaO | 0 | 0 | 0 | 0 | 0 |
| SrO | 0 | 0 | 0 | 0 | 0 |
| BaO | 0 | 0 | 0 | 0 | 0 |
| Al₂O₃ | 0 | 0 | 0 | 0 | 0 |
| Y₂O₃ | 0 | 0 | 0 | 0 | 0 |
| Yb₂O₃ | 0 | 0 | 0 | 0 | 0 |
| TiO₂ | 0 | 0 | 0 | 0 | 0 |
| Ta₂O₅ | 1 | 2 | 4 | 3 | 4 |
| Nb₂O₅ | 0 | 0 | 0 | 0 | 0 |
| WO₃ | 0 | 1 | 0 | 3 | 5 |
| Bi₂O₃ | 0 | 0 | 0 | 0 | 0 |
| Sb₂O₃ (*) | 0.01 | 0.01 | 0.01 | 0.01 | 0.01 |
| Refractive | 1.768 | 1.774 | 1.802 | 1.821 | 1.850 |
| index (nd) | | | | | |
| Abbe's | 49.2 | 47.1 | 45.5 | 42.7 | 40.2 |
| number | | | | | |
| (vd) | | | | | |
| Sag | 645 | 615 | 635 | 640 | 635 |
| temperature | | | | | |
| (° C.) | | | | | |
| Transition | 605 | 570 | 595 | 600 | 590 |
| temperature | | | | | |
| (° C.) | | | | | |
| Liquidus | 1010 | 990 | 1010 | 1010 | 1100 |
| temperature | | | | | |
| (° C.) | | | | | |
| Press-molding | 700 | 670 | 695 | 705 | 700 |
| temperature | | | | | |
| (° C.) | | | | | |
| in precision | | | | | |
| press molding | | | | | |
| method 1 | | | | | |
| (heated | | | | | |
| together) | | | | | |
| Press-molding | 710 | 680 | 705 | 715 | 710 |
| temperature | | | | | |
| (° C.) | | | | | |
| in precision | | | | | |
| press molding | | | | | |
| method 2 | | | | | |
| (heated | | | | | |
| separately) | | | | | |

(*) The content of Sb₂O₃ was calculated on the basis of the total amount of the other components

### Example 2

### Example Using Mold of Which the Mold Material is Silicon Nitride

Aspherical lenses were mass-produced by precision press molding in the same manner as in the precision press molding method 1 in Example 1 except that the mold was replaced with a mold having an upper mold member 1 and a lower mold member 2 which were made from silicon nitride and having a molding surface provided with a hard carbon mold release film, and that the preforms were replaced with preforms with a carbon film each which preforms were formed of the glass 2.

As a result, the resultant lenses were excellent in surface accuracy and appearance until the press-molding was carried out 500 times. While the lens obtained when the number of times of the pressing reached 1,000 times was slightly poor in surface accuracy and appearance as compared with the lens that was obtained when the number of times of the pressing reached 500 times, it had sufficient functions as a lens.

### Example 3

### Example Using Mold of Which the Mold Material is Zirconium Oxide

Aspherical lenses were mass-produced in the same manner as in the precision press molding method 1 in Example 1 except that the mold was replaced with a mold having an upper mold member 1 and a lower mold member 2 made from zirconium oxide and having a molding surface provided with a hard carbon mold release film and that the preforms were replaced with preforms with a carbon film each which preforms were formed of the glass 3.

As a result, the resultant lenses were excellent in surface accuracy and appearance until the pressing was carried out 500 times. While the lens obtained when the number of times of the pressing reached 1,000 times was slightly poor in surface accuracy and appearance as compared with the lens that was obtained when the number of times of the pressing reached 500 times, it had sufficient functions as a lens.

### Example 4

### Example Using Mold of Which the Mold Material is Aluminum Oxide

Aspherical lenses were mass-produced in the same manner as in the precision press molding method 2 in Example 1 except that the mold was replaced with a mold having an upper mold member 1 and a lower mold member 2 made from aluminum oxide and having a molding surface provided with a hard carbon mold release film and that the preforms were replaced with preforms with a carbon film each which preforms were formed of the glass 5.

As a result, the resultant lenses were excellent in surface accuracy and appearance until the pressing was carried out 500 times. While the lens obtained when the number of times of the pressing reached 1,000 times was slightly poor in surface accuracy and appearance as compared with the lens that was obtained when the number of times of the pressing reached 500 times, it had sufficient functions as a lens.

### Example 5

### Example Using Mold of Which the Mold Material is Tungsten Carbide (Free of Metal-Based Binder)

Aspherical lenses were mass-produced in the same manner as in the precision press molding method 2 in Example 1 except that the mold was replaced with a mold having an upper mold member 1 and a lower mold member 2 made from tungsten carbide (free of a metal-based binder) and having a molding surface provided with a hard carbon mold release film and that the preforms were replaced with preforms with a carbon film each which preforms were formed of the glass 1.

As a result, the resultant lenses were excellent in surface accuracy and appearance until the pressing was carried out 500 times. While the lens obtained when the number of times of the pressing reached 1,000 times was slightly poor in surface accuracy and appearance as compared with the lens that was obtained when the number of times of the pressing reached 500 times, it had sufficient functions as a lens.

### Comparative Example 1

### Example Using Mold or Which the Mold Material is Tungsten Carbide (Containing a Cobalt Binder)

Aspherical lenses were mass-produced in the same manner as in the precision press molding method 2 in Example 1 except that the mold was replaced with a mold having an upper mold member 1 and a lower mold member 2 made from tungsten carbide containing a cobalt binder and having a molding surface provided with a platinum alloy mold release film and that the preforms were replaced with preforms with a carbon film each which preforms were formed of the glass 1.

As a result, the mold release film was deteriorated in a short period of time, glass molded products came to have cloudy surfaces, or adhesion frequently took place between the glass and the mold. When the press-molding was carried out 100 times, defective products were formed.

### INDUSTRIAL UTILITY

According to the present invention, there can be highly accurately and highly productively mass-produced optical elements such as various lenses, diffraction gratings, lens arrays, prisms, and the like which are formed of a glass having a high refractive index.

1. A process for mass-producing optical elements, which comprises repeating the step of precision press-molding a glass preform formed of an optical glass having an Abbe's number (νd) of 30 to less than 40 and a refractive index (nd) of over 1.84 or an optical glass having an Abbe's number (νd) of 40 to 50 and a refractive index (nd) that satisfies the expression (1),
nd>2.16−0.008×νd (1)
with a mold made from a material having heat durability against temperatures of higher than 650° C. to produce an optical element formed of said glass.

2. A process for mass-producing optical elements, which comprises repeating the step of precision press-molding a glass preform formed of an optical glass having an Abbe's number (νd) of 30 to less than 40 and a refractive index (nd) of over 1.84 or an optical glass having an Abbe's number (νd) of 40 to 50 and a refractive index (nd) that satisfies the expression (1),
nd>2.16−0.008×νd (1)
with a mold which is made from a mold material selected from silicon carbide, silicon nitride, chromium oxide, zirconium oxide, aluminum oxide or tungsten carbide (free of any metal-based binder) and which has a mold release film formed on its molding surface to produce an optical element formed of said optical glass.

3. The process for mass-producing optical elements as recited in claim 2, wherein the mold release film is a carbon-containing film.

4. The process for mass-producing optical elements as recited in any one of claims 1 to 3, wherein the preform to be precision press-molded is provided with an adhesion-preventing film on a surface thereof.

5. The process for mass-producing optical elements as recited in any one of claims 1 to 43, wherein said optical glass contains B₂O₃ and La₂O₃ as essential components.

6. The process for mass-producing optical elements as recited in claim 5, wherein said optical glass further contains Gd₂O₃.

7. The process for mass-producing optical elements as recited in claim 5, wherein said optical glass further contains ZnO.
